(19) United States
(12) Patent Application Publication
(10) Pub. No.: US 2025/0178164 A1
(43) Pub. Date: Jun. 5, 2025

(54) Tool Having Pawl Travel Control

(71) Applicant: Snap-on Incorporated, Kenosha, WI (US)

(72) Inventors: David T. Ross, Kenosha, WI (US); Daniel M. Eggert, Kenosha, WI (US)

(21) Appl. No.: 18/957,635

(22) Filed: Nov. 22, 2024

Related U.S. Application Data
(60) Provisional application No. 63/606,476, filed on Dec. 5, 2023.

(51) Int. Cl. B25B 13/46

(52) U.S. Cl. CPC B25B 13/463

(57) ABSTRACT

A tool includes a head portion having a cavity, a ratchet gear, a pawl carrier, first and second pawls, and a raised portion. The ratchet gear is rotatably disposed in the cavity and includes a drive portion and a toothed portion. The pawl carrier is rotatably disposed in the cavity and includes a groove. The first and second pawls are adapted to selectively engage with the toothed portion for selecting one of either first and second drive directions. The raised portion is disposed on a portion of a perimeter of the cavity and protrudes radially inward towards a center point of the cavity. A first side of the raised portion engages with the pawl carrier to arrest rotation of the pawl carrier in the first drive direction and a second side of the raised portion engages with the pawl carrier to arrest rotation of the pawl carrier in the second drive direction.

### CROSS-REFERENCE TO RELATED APPLICATION

The present application claims priority to U.S. Provisional Application No. 63/606,476 filed on Dec. 5, 2023, the entire contents of which is hereby incorporated by reference.

### BACKGROUND

Handheld tools, such as wrenches and/or ratchets, are used in a variety of industries. The ratchet may include a drive portion that engages with, and provides torque to, a fastening device, such as a nut, for tightening or loosening of the nut. In some ratchets, a dual pawl, supported by a pawl carrier, engages with the drive portion to allow rotation of the drive portion in a clockwise direction and restrict rotation in a counterclockwise direction. The dual pawl may be operable to change the direction of rotation of the drive portion such that the drive portion restricts rotation in the clockwise direction and allows rotation in the counterclockwise direction. When high amounts of torque are produced between the drive portion and the fastening device, deflection of the ratchet may occur. Deflection of the ratchet under high loads may cause the pawl carrier to exert a force greater than the force restricting rotation of the drive portion which may lead to over-rotation (e.g., slipping) of the pawl carrier within the ratchet.

### OVERVIEW

In an example embodiment, a tool is provided. The tool includes a head portion having a cavity. The tool also includes a ratchet gear rotatably disposed in the cavity and having a drive portion and a toothed portion, where the drive portion projects outwardly from the cavity and is adapted to transmit torque to a work piece. The tool further includes a pawl carrier rotatably disposed in the cavity and including a groove. The tool additionally includes first and second pawls adapted to selectively engage with the toothed portion for selecting one of either first and second drive directions. Each of the first and second pawls includes pawl teeth, a surface opposite the pawl teeth, and a projection extending outwardly from the surface. The projection is adapted to engage the groove when the pawl carrier is rotated to cause one of the first and second pawls to disengage from the toothed portion and the other of the first and second pawls to engage the toothed portion. The tool also includes a raised portion disposed on a portion of a perimeter of the cavity and protruding radially inward towards a center point of the cavity. A first side of the raised portion engages with the pawl carrier to arrest rotation of the pawl carrier in the first drive direction and a second side of the raised portion engages with the pawl carrier to arrest rotation of the pawl carrier in the second drive direction.

In an embodiment of the tool, the first side of the raised portion is disposed opposite the second side.

In an embodiment of the tool, the first and second sides of the raised portion have an arcuate profile.

In such embodiments of the tool, the arcuate profile of the first and second sides is the same.

In such embodiments of the tool, the cavity has a first radius and the arcuate profile of the first and second sides is defined by a second radius less than the first radius.

In an embodiment of the tool, the raised portion further comprises a third side disposed between the first and second sides, where the third side forms an angle with the first and second side.

In such embodiments of the tool, the third side has an arcuate profile different than the first and second sides.

In such embodiments of the tool, the first side and the third side form a first peak and the second side and third side form a second peak.

In such embodiments of the tool, the first peak arrests rotation of the pawl carrier in the first drive direction and the second peak arrests rotation of the pawl carrier in the second drive direction.

In such embodiments of the tool, a ball is partially recessed within the cavity such that the ball is selectively engaged with the pawl carrier, and where the first peak is on a first side of the ball and the second peak is on a second side of the ball.

In another example embodiment, a tool head including a cavity, and a ratchet gear assembly arranged within in the cavity is disclosed. The tool head includes a pawl carrier arranged in the cavity to cooperate with the ratchet gear assembly a first pawl and a second pawl supported within the pawl carrier and positioned to selectively engage with the ratchet gear assemble, wherein the selectively engagement includes the first pawl engaging the ratchet gear assembly to select a first drive direction, and the second pawl engaging the ratchet gear assembly to select a second drive direction; and a raised portion provided on a perimeter of the cavity, wherein the raised portion extends radially inward towards a center point of the cavity, wherein a first side of the raised portion cooperates with the pawl carrier to arrest rotation of the pawl carrier in the first drive direction, and wherein a second side of the raised portion cooperates with the pawl carrier to arrest rotation of the pawl carrier in the second drive direction.

Other embodiments will become apparent to those of ordinary skill in the art by reading the following detailed description, with reference where appropriate to the accompanying drawings.

### BRIEF DESCRIPTION OF THE DRAWINGS

Example embodiments are described herein with reference to the drawings.

FIG. 1 illustrates a tool, according to an example embodiment.

FIG. 2 illustrates a perspective view of a pawl carrier and pawls, according to an example embodiment.

FIG. 3 illustrates a front view of a head portion of a tool, according to an example embodiment.

FIG. 4 illustrates a cross-sectional view of a tool head assembly, according to an example embodiment.

FIG. 5 illustrates a cross-sectional view of the tool head assembly of FIG. 4 in a deflected state.

The drawings are schematic and not necessarily to scale. In the drawings, similar symbols typically identify similar components, unless context dictates otherwise.

### DETAILED DESCRIPTION

This description describes several example embodiments, at least some which relate to a tool for reducing over-rotation (e.g., slip or over-travel) of a pawl carrier. In example embodiments, the tool may include a head portion having a cavity. A ratchet gear, having a drive portion and a toothed portion, may be disposed in the cavity. The drive portion may project outwardly from the cavity and may be adapted to transmit torque to a work piece. A pawl carrier may be disposed in the cavity and include a groove. First and second pawls may each include pawl teeth, a surface opposite the pawl teeth, and a projection extending outwardly from the surface. The first and second pawls may be adapted to selectively engage with the toothed portion for selecting one of either a first and a second drive directions. The projection may be adapted to engage with the groove when the pawl carrier is rotated to cause one of the first and second pawls to disengage from the toothed portion and the other of the first and second pawls to engage the toothed portion. A raised portion may be disposed on a portion of a perimeter of the cavity. The raised portion may protrude radially inward towards a center point of the cavity. A first side of the raised portion may engage with the pawl carrier to arrest rotation of the pawl carrier in the first drive direction and a second side of the raised portion may engage with the pawl carrier to arrest rotation of the pawl carrier in the second drive direction. The raised portion may reduce a likelihood and/or amount of undesirable rotation, such as over-traveling, of the pawl carrier while torque is being transmitted to the work piece in either the first and/or second drive directions. For example, the raised portion may control an amount of travel of the pawl carrier.

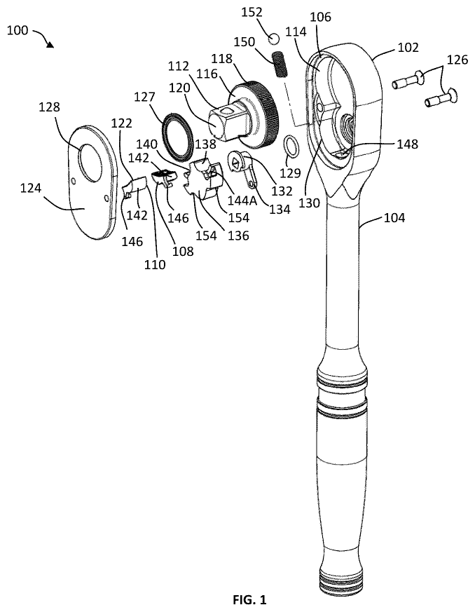

FIG. 1 illustrates a tool 100, according to an example embodiment. The tool 100, such as, for example, a dual-pawl ratchet wrench, may have a head portion 102 and a handle portion 104. The handle portion 104 may be attachable/detachable or integrated with the head portion 102. The head portion 102 includes a cavity 106 for receiving components of the tool 100 for providing torque to a work piece (not shown) such as a socket and/or a fastener.

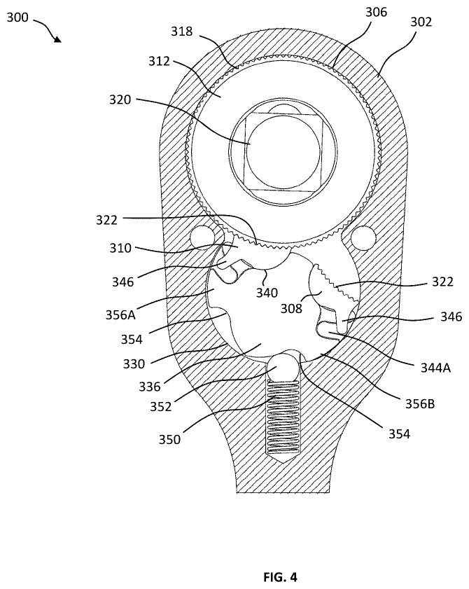

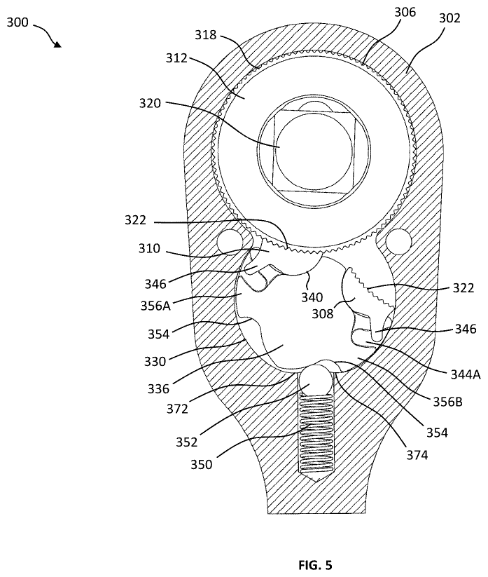

The head portion 102 includes first and second pawls 108, 110 disposed in the cavity 106. The first and second pawls 108, 110 are selectively engageable with a ratchet gear 112 that is operatively engageable with the work piece in a well-known manner. When the first pawl 108 engages the ratchet gear 112, torque drive is permitted with rotation of the head portion 102 in a first rotational direction while ratcheting occurs with rotation of the head portion 102 in a second rotational drive direction opposite the first rotational drive direction. When the second pawl 110 is engaged with the ratchet gear 112 (as illustrated in FIGS. 4 and 5), the first pawl 108 disengages the ratchet gear 112, and torque drive is permitted with rotation of the head portion 102 in the second rotational drive direction while ratcheting occurs with rotation of the head portion 102 in the first rotational drive direction.

The cavity 106 includes portions for respectively receiving and retaining components of the tool 100 therein. The ratchet gear 112 is received in a first portion of the cavity 106, referred to herein as a drive cavity portion 114. In some examples, the drive cavity portion 114 is large and generally circular. The ratchet gear 112 has a generally circular body portion 116 with a circumferential toothed portion 118, and a drive portion 120, such as, for example, a square drive lug, projecting from the body portion 116. The toothed portion 118 selectively engages pawl teeth 122 formed on each of the pawls 108, 110 for selective engagement with the pawls 108, 110 to provide torque drive through the drive portion 120 in either of the first and second rotational drive directions.

A cover plate 124 is secured to the head portion 102 to enclose the components of the tool 100 in the cavity 106. In some examples, the cover plate 124 is retained to the head portion 102 using fasteners 126, such as, for example, screws, rivets, etc. The cover plate 124 includes an opening 128, such as, for example, a circular bore, through which the drive portion 120 projects for operative engagement with the work piece. The opening 128 also defines a bearing surface for the drive portion 120 to retain and position the ratchet gear 112. A cover plate seal 127 may mate between surfaces of the cover plate 124 and the ratchet gear 112 to reduce ingress of foreign material (e.g., dirt, debris, and/or fluids) through the opening 128.

The first and second pawls 108, 110 are disposed in a second portion of the cavity 106, referred to herein as the pawl cavity portion 130. The drive cavity portion 114 and pawl cavity portion 130 overlap or communicate to allow the first and second pawls 108, 110 to selectively move into and out of engagement with the toothed portion 118 of the ratchet gear 112.

An actuator 132 for selectively causing the engagement and disengagement of the first and second pawls 108, 110 with the ratchet gear 112 is provided. In some examples, the actuator 132 is disposed in the pawl cavity portion 130. The actuator 132 extends through the head portion 102 wherein a lever portion 134 of the actuator 132 is positioned on the outside of the head portion 102 and is adapted to be manually operated by a user to select a drive direction of the tool. A seal 129 is circumferentially disposed around the lever portion 134 to impede or prevent contaminants or liquid from entering the cavity 106. In some examples, the actuator 132 is assembled with the head portion 102 by inserting the lever portion 134 into the pawl cavity portion 130 from a first side of the head portion 102, and by extending the lever portion 134 through an opening in the head portion 102 to a second side of the head portion 102, which promotes the ability to utilize the seal 129 for preventing ingress of contaminants. The actuator 132 may be sized to prevent complete passage through the opening, so that the actuator 132 may be mounted in only one direction.

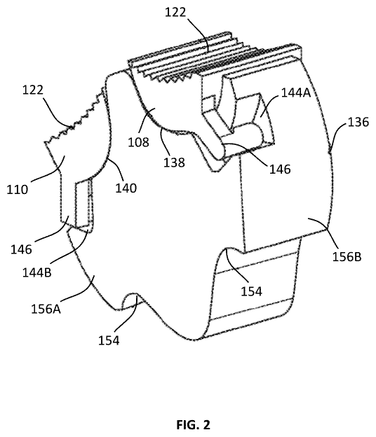

In some examples, the actuator 132 is pivotally coupled to a pawl carrier 136 such that the pawl carrier 136 co-rotates with the actuator 132 to selectively position one of the pawls 108, 110 into engagement with the ratchet gear for selecting the torque drive direction. A perspective view of the pawl carrier 136 and pawls 108, 110 is depicted in FIG. 2. As shown in FIG. 1 and FIG. 2, the pawl carrier 136 includes first and second recesses 138, 140. Each of the pawls 108, 110 includes a surface 142 opposite the pawl teeth that is correspondingly shaped to substantially correspond to the first and second recesses 138, 140. In some examples, the surface 142 is circular/arcuately shaped, and the first and second recesses 138, 140 have a concavity or convexity substantially similar to that of the circular/arcuately shaped surface 142 of each of the pawls 108, 110. The pawl carrier 136 includes a pair of detents 154 partially defined by first and second feet 156A, 156B. The detents 154 may selectively engage a ball 152, retained by a biasing member 150 within a bore 148 of the tool 100, when the actuator 132 is disposed in the proper position for selection of the first and second torque drive directions.

The pawl carrier also includes a groove, and preferably first and second grooves 144A, 144B, disposed adjacent the first and second recesses 138, 140. In some examples, the grooves 144A, 144B are formed along an arcuately shaped path to substantially correspond to the concavity or convexity shape of the first and second recesses 138, 140. The first and second pawls 108, 110 each includes a projection 146 adapted to respectively slidably engage the grooves 144A, 144B. For example, the projection 146 of the first pawl 108 engages the first groove 144A, and the projection 146 of the second pawl 110 engages the second groove 144B. Although two separate grooves 144A, 144B are illustrated, in other examples a single groove adapted to selectively engage the projection 146 of the respective first and second pawls 108, 110 may be used. In some examples, an end portion of the projection 146 may have an arcuate (e.g., rounded) profile, while in other examples the end portion of the projection 146 may be planar.

In operation, as the pawl carrier 136 is shifted by the actuator 132 to a first position to select a first rotational drive direction, the first groove 144A engages the projection 146 of the first pawl 108 to push the first pawl 108 into engagement with the ratchet gear 112. Simultaneously, the second groove 144B engages the projection 146 of the second pawl 110 to cause the second pawl 110 to disengage from the ratchet gear 112. Accordingly, the pawl teeth 122 of the first pawl 108 remain in engagement with the toothed portion 118 of the ratchet gear 112 when the head portion 102 is moved in the first rotational drive direction. As the pawl carrier 136 is shifted by the actuator 132 to a second position to select a second rotational drive direction, the second groove 144B engages the projection 146 of the second pawl 110 to push the second pawl 110 into engagement with the ratchet gear 112. Simultaneously, the first groove 144A engages the projection 146 of the first pawl 108 to cause the first pawl 108 to disengage from the ratchet gear 112. Accordingly, the pawl teeth 122 of the second pawl 110 engages the toothed portion 118 of the ratchet gear 112 when the head portion 102 is moved in the second rotational drive direction.

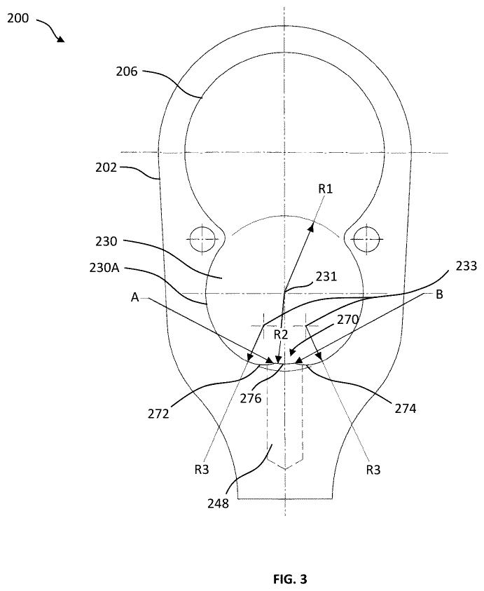

FIG. 3 illustrates a front view of a head portion 202 of a tool 200, according to an example embodiment. The head portion 202 includes a cavity 206 having a pawl cavity portion 230. A raised portion 270 is disposed within the pawl cavity portion 230 and includes a first side 272, a second side 274 opposite the first side 272, and a third side 276 disposed between the first and second sides 272, 274. One or more aspects of the tool 200 may be similar to, or the same as, the tool 100 described above. Further, one or more aspects of the tool 200, such as the tool head 202, may be combinable with one or more aspects of the tool 100.

The raised portion 270 may be disposed on a portion of a perimeter 230A (e.g., an inner perimeter and/or edge) of the pawl cavity portion 230. The raised portion 270 may protrude radially inward towards a center point 231 of the pawl cavity portion 230. By protruding radially inward towards the center point 231, a distance from the center point 231 to the raised portion 270 may be less than a distance from the center point 231 to the perimeter 230A of the pawl cavity portion 230. For example, a first radius (R1) from the center point 231 to the perimeter 230A may be greater than a second radius (R2) from the center point 231 to the third side 276. In such examples, the third side 276 may include an arcuate profile corresponding to the second radius (R2) from the center point 231. However, in other examples the third side 276 may have another profile, such as flat or rounded towards the center point 231. In some examples, the raised portion 270 may take the form of a stop or an interrupter.

In some examples, the first side 272 may have an arcuate profile. The arcuate profile of the first side 272 may be defined by a third radius (R3) originating from a point 233 offset from the center point 231. The point 233 may be offset from the center point 231 such that the third radius (R3) is tangential to the perimeter 230A. Thus, in examples where the arcuate profile of the first side 272 is defined by the third radius (R3), the first side 272 may be tangential to the perimeter 230A. Similarly, the second side 274 may have an arcuate profile. The arcuate profile of the second side 274 may similarly be defined by the third radius (R3). In some examples, one or more dimensions of the second side 274 may mirror corresponding dimensions of the first side 272. For example, the arcuate profile of the second side 274 may be the same as or substantially similar to the arcuate profile of the first side 272. The third radius (R3) may be different than the second radius (R2) such that the arcuate profile of the first and second sides 272, 274 may be different than the arcuate profile third side 276. While the first and second sides 272, 274 are shown as including an arcuate profile, in other examples the first and/or second side 272 and/or 274 may be planar (e.g., linearly sloped) and or rounded (e.g., convexly rounded). Further, one or more dimensions of the first side 272 may be different than one or more dimensions of the second side 274. For example, the first side 272 may be planar while the second side 274 may be arcuate, or vice versa.

The third radius (R3) may be less than the first radius (R1). Originating the third radius (R3) from the point 233 within the pawl cavity portion 230 may produce a concave arcuate profile on the first and second sides 272, 274. Because the point 233 is offset from the center point 231, the arcuate profile of the first and second sides 272, 274 may be non-concentric with the arcuate profile of the third side 276 which is based on the second radius (R2) originating from the center point 231. In such examples, the first side 272 may converge with the third side 276 at a first end to form a first peak (shown in FIG. 3 as peak A). Similarly, the second side 274 may converge with the third side 276 at a second end to form a second peak (shown in FIG. 3 as peak B). The first and second peaks A, B may each respectively define a point furthest away radially from the perimeter 230A. That is, when traveling along the perimeter 230A the first and second peaks A, B may be radially disposed on the raised portion 270 furthest away from the perimeter 230A. The first and second peaks A, B may produce a maximum amount of interference between the pawl carrier and the raised portion 270 to resist further rotation of the pawl carrier within the pawl cavity portion 230.

Including an arcuate profile on either the first side 272 and/or the second side 274 may reduce an amount of travel of a pawl carrier disposed within the pawl cavity portion 230. For example, torque applied on the tool 200 may cause rotation (e.g., travel) of the pawl carrier within the pawl cavity portion 230. The pawl carrier may contact either the first or second side 272, 274 depending whether the tool 200 is being rotated clockwise or counterclockwise. The arcuate profile of the first and second sides 272, 274 protruding inwardly away from the perimeter 230A may arrest and/or reduce an amount of travel of the pawl carrier by increasing frictional resistance. Further, manufacturing of the first, second, and/or third side(s) 272, 274, and/or 276 may be simplified and/or expedited by including an arcuate profile compared to a flat, planar, or linear profile. For example, the first, second, and/or third side(s) 272, 274, and/or 276 may be formed through milling with a drill bit having a radius equal to the aforementioned radii (R1, R2, R3). Thus, including an arcuate profile on one or more sides of the raised portion 270 may increase manufacturing efficiency and/or mitigate undesirable rotation of the pawl carrier which may otherwise result in over-travel.

As shown, the head portion 202 may further include a bore 248 disposed proximal to the pawl cavity portion 230. The bore 248 may serve to retain a biasing member, such as the spring 150 and ball 152 shown in FIG. 1, that may be selectively engaged with a pawl carrier during actuation of the tool 200. In some examples, the bore 248 may be disposed proximal to the raised portion 270. For example, the bore 248 may be aligned with the raised portion 270 such that the raised portion 270 is disposed on either side of the bore 248. A portion of the first side 272 and/or the first peak (A) of the raised portion 270 may be on a first side of the bore 248. A portion of the second side 274 and/or the second peak (B) may be on a second side of the bore 248. The second side of the bore 248 may be opposite the first side of the bore 248.

FIG. 4 illustrates a cross-sectional view of a head portion 302 of tool 300 in an assembled state, according to an example embodiment. FIG. 5 illustrates a cross-sectional view of the tool 300 of FIG. 4 in a deflected state. The head portion 302 of the tool 300 includes a cavity 306 having a pawl cavity portion 330, a ratchet gear 312 disposed in the cavity 306, and a pawl carrier 336 coupled to first and second pawls 308, 310 disposed in the pawl cavity portion 330. A drive portion 320, coupled to the ratchet gear 312, engages with a work piece to transmit torque between the tool 300 and the work piece. The ratchet gear 312 includes a toothed portion 318 that may be engaged with pawl teeth 322 of either the first and/or second pawls 308, 310. The first and second pawls 308, 310 include a projection 346 that may be engaged with a groove 344A of the pawl carrier 336. The pawl carrier 336 includes one or more recesses 340 that each receive a portion of the first or second pawls 308, 310, a detent 354 that may be selectively engaged with a ball 352 coupled to a biasing member 350, and one or more feet, such as first and second feet 356A, 356B. One or more aspects of the tool 300 may be similar to, or the same as, the tool 100 and/or 200 described above. Further, one or more aspects of the tool 300, may be combinable with one or more aspects of the tool 100 and/or 200.

In some examples, the pawl cavity portion 330 may further include the raised portion 270, shown and described in FIG. 3. The raised portion 270 may be disposed on a portion of the perimeter of the pawl cavity portion 330 proximal to the ball 352. FIG. 5 illustrates a first side 372 and a second side 374 which may correspond to the first and second sides 272, 274 of the raised portion 270 shown in FIG. 3. The first side 372 may be disposed on a first side of the ball 352 and the second side 374 may be on a second side of the ball 352 opposite the first side. The first side 372 may engage with the first foot 356A of the pawl carrier 336 when the pawl teeth 322 of the first pawl 308 are engaged with the toothed portion 318 of the ratchet gear 312. Similarly, the second side 374 may engage with the second foot 356B of the pawl carrier 336 when the pawl teeth 322 of the second pawl 310 are engaged with the toothed portion 318 of the ratchet gear 312. Beneficially, interaction between the first side 372 and the first foot 356A and interaction between the second side 374 and the second foot 356B may reduce an amount of undesirable rotation of the pawl carrier 336 during use.

For example, as shown in FIGS. 4 and 5 the second pawl 310 is engaged with the ratchet gear 312. As torque produced in the tool 300 is transferred to a work piece through the drive portion 320, reactionary forces in the head portion 302 may cause rotation (e.g., clockwise or counterclockwise) of the pawl carrier 336 within the pawl cavity portion 330. The rotation of the pawl carrier 336 may place the second foot 356B in communication with the second side 374. The arcuate profile of the second side 374 may serve to resist further rotation of the pawl carrier 336, for example by increasing frictional forces between the second foot 356B and the second side 374. The second peak (B) (shown in FIG. 3) may be radially disposed at a distance away from the perimeter of the pawl cavity portion 330 such that the second foot 356B may be estopped from rotating over the second peak (B). For example, the pawl carrier 336 may be constrained from non-rotational movement within the pawl cavity portion 330. The second peak (B) may be radially projected into the pawl cavity portion 330 at a distance greater than a non-rotational displacement distance of the second foot 356B. When the second foot 356B is engaged with the second side 374, the second foot 356B may be resisted from rotating over the second peak (B). The first peak (A) (shown in FIG. 3) on the first side 372 may interact with the first foot 356A in the same and/or a similar manner as the second peak (B).

When the first pawl 308 is engaged with the ratchet gear 312, engagement with the work piece may produce torque that causes rotation of the pawl carrier 336 in a direction opposite engagement of the second pawl 310 with the ratchet gear 312. In such examples, the first foot 356A may interact with the first side 372 in a same or similar manner as the second foot 356B and second side 374 to resist rotation of the pawl carrier 336. Thus, the first side 372 may interact with the pawl carrier 336 to resist rotation in a first direction and the second side 374 may interact with the pawl carrier 336 to resist rotation in a second direction opposite the first direction. This is illustrated in FIG. 5 where when the tool 300 is in the deflected state, such as when engaged with the work piece, the second foot 356B is disposed at a distance from the ball 352 such that a gap exists between the detent 354 and the ball 352. By selectively resisting undesirable rotation of the pawl carrier 336 during use, the raised portion may allow for higher torque loads to be produced between the tool 300 and the work piece which may allow for a user to effectively engage the work piece. For example, fasteners or sockets that may previously have required a torque that caused over-travel to occur in the pawl carrier of the tool may now be worked on (e.g., tightened or loosened) with minimal to no slipping.

It should be understood that the arrangements described herein and/or shown in the drawings are for purposes of example only and are not intended to be limiting. As such, those skilled in the art will appreciate that other arrangements and elements (e.g., machines, interfaces, functions, orders, and/or groupings of functions) can be used instead, and some elements can be omitted altogether.

While various aspects and embodiments are described herein, other aspects and embodiments will be apparent to those skilled in the art. The various aspects and embodiments disclosed herein are for purposes of illustration and are not intended to be limiting, with the true scope being indicated by the claims, along with the full scope of equivalents to which such claims are entitled. It is also to be understood that the terminology used herein for the purpose of describing embodiments only, and is not intended to be limiting.

In this description, the articles “a,” “an,” and “the” are used to introduce elements and/or functions of the example embodiments. The intent of using those articles is that there is one or more of the introduced elements and/or functions.

In this description, the intent of using the term “and/or” within a list of at least two elements or functions and the intent of using the terms “at least one of,” “at least one of the following,” “one or more of,” “one or more from among,” and “one or more of the following” immediately preceding a list of at least two components or functions is to cover each embodiment including a listed component or function independently and each embodiment including a combination of the listed components or functions. For example, an embodiment described as including A, B, and/or C, or at least one of A, B, and C, or at least one of: A, B, and C, or at least one of A, B, or C, or at least one of: A, B, or C, or one or more of A, B, and C, or one or more of: A, B, and C, or one or more of A, B, or C, or one or more of: A, B, or C is intended to cover each of the following possible embodiments: (i) an embodiment including A, but not B and not C, (ii) an embodiment including B, but not A and not C, (iii) an embodiment including C, but not A and not B, (iv) an embodiment including A and B, but not C, (v) an embodiment including A and C, but not B, (v) an embodiment including B and C, but not A, and/or (vi) an embodiment including A, B, and C. For the embodiments including component or function A, the embodiments can include one A or multiple A. For the embodiments including component or function B, the embodiments can include one B or multiple B. For the embodiments including component or function C, the embodiments can include one C or multiple C. In accordance with the aforementioned example and at least some of the example embodiments, “A” can represent a component, “B” can represent a system, and “C” can represent a device.

The use of ordinal numbers such as “first,” “second,” “third” and so on is to distinguish respective elements rather than to denote an order of those elements unless the context of using those terms explicitly indicates otherwise. Further, the description of a “first” element, such as a first arm and first portion, does not necessitate the presence of a second or any other element, such as a second arm and second portion.

Implementations of the present disclosure can thus relate to one of the enumerated examples (EE) listed below.
EE 1 is a tool comprising: a head portion having a cavity; a ratchet gear rotatably disposed in the cavity and having a drive portion and a toothed portion, wherein the drive portion projects outwardly from the cavity and is adapted to transmit torque to a work piece; a pawl carrier rotatably disposed in the cavity and including a groove; first and second pawls adapted to selectively engage with the toothed portion for selecting one of either first and second drive directions, wherein each of the first and second pawls includes pawl teeth, a surface opposite the pawl teeth, and a projection extending outwardly from the surface, wherein the projection is adapted to engage the groove when the pawl carrier is rotated to cause one of the first and second pawls to disengage from the toothed portion and the other of the first and second pawls to engage the toothed portion; and a raised portion disposed on a portion of a perimeter of the cavity and protruding radially inward towards a center point of the cavity, wherein a first side of the raised portion engages with the pawl carrier to arrest rotation of the pawl carrier in the first drive direction and a second side of the raised portion engages with the pawl carrier to arrest rotation of the pawl carrier in the second drive direction.
EE 2 is the tool of EE 1, wherein the first side of the raised portion is disposed opposite the second side.
EE 3 is the tool of EE 1 or EE 2, wherein the first and second sides of the raised portion have an arcuate profile.
EE 4 is the tool of EE 3, wherein the arcuate profile of the first and second sides is the same.
EE 5 is the tool of EE 3 or EE 4, wherein the cavity has a first radius and the arcuate profile of the first and second sides is defined by a second radius less than the first radius.
EE 6 is the tool of any of EEs 1-5, wherein the raised portion further comprises a third side disposed between the first and second sides, wherein the third side forms an angle with the first and second side.
EE 7 is the tool of any of EEs 3-6, wherein the third side has an arcuate profile different than the first and second sides.
EE 8 is the tool of EE 6 or EE 7, wherein the first side and the third side form a first peak and the second side and third side form a second peak.
EE 9 is the tool of EE 8, wherein the first peak arrests rotation of the pawl carrier in the first drive direction and the second peak arrests rotation of the pawl carrier in the second drive direction.
EE 10 is the tool of EE 8 or EE 9, wherein a ball is partially recessed within the cavity such that the ball is selectively engaged with the pawl carrier, and wherein the first peak is on a first side of the ball and the second peak is on a second side of the ball.
EE 11 is a tool head including a cavity, and a ratchet gear assembly arranged within in the cavity, the tool head comprising a pawl carrier arranged in the cavity to cooperate with the ratchet gear assembly; a first pawl and a second pawl supported within the pawl carrier and positioned to selectively engage with the ratchet gear assemble, wherein the selectively engagement includes the first pawl engaging the ratchet gear assembly to select a first drive direction, and the second pawl engaging the ratchet gear assembly to select a second drive direction; and a raised portion provided on a perimeter of the cavity, wherein the raised portion extends radially inward towards a center point of the cavity, wherein a first side of the raised portion cooperates with the pawl carrier to arrest rotation of the pawl carrier in the first drive direction, and wherein a second side of the raised portion cooperates with the pawl carrier to arrest rotation of the pawl carrier in the second drive direction.
EE 12 is the tool head of EE 11, wherein the first side of the raised portion is disposed opposite the second side.
EE 13 is the tool head of EE 11 or EE 12, wherein the first and second sides of the raised portion have an arcuate profile.
EE 14 is the tool head of EE 13, wherein the arcuate profile of the first side and is the same as the arcuate profile of the second side.
EE 15 is the tool head of EE 13 or EE 14, wherein the cavity has a first radius and the arcuate profile of the first and second sides is defined by a second radius less than the first radius.
EE 16 is the tool head of any EEs 11-15, wherein the raised portion further comprises a third side disposed between the first and second sides, wherein the third side forms an angle relative to the first and second side.
EE 17 is the tool head of any EEs 13-16, wherein the third side has an arcuate profile different than the arcuate profile of the first and second sides.
EE 18 is the tool head of EE 16 or EE 17, wherein the first side and the third side form a first peak and the second side and third side form a second peak.
EE 19 is the tool head of EE 18, wherein the first peak arrests rotation of the pawl carrier in the first drive direction and the second peak arrests rotation of the pawl carrier in the second drive direction.
EE 20 is the tool head of EE 18 or EE 19, wherein a ball is partially recessed within the cavity such that the ball is selectively engaged with the pawl carrier, and wherein the first peak is on a first side of the ball and the second peak is on a second side of the ball.

What is claimed is:

1. A tool comprising:
a head portion having a cavity;
a ratchet gear rotatably disposed in the cavity and having a drive portion and a toothed portion, wherein the drive portion projects outwardly from the cavity and is adapted to transmit torque to a work piece;
a pawl carrier rotatably disposed in the cavity and including a groove;
first and second pawls adapted to selectively engage with the toothed portion for selecting one of either first and second drive directions, wherein each of the first and second pawls includes pawl teeth, a surface opposite the pawl teeth, and a projection extending outwardly from the surface, wherein the projection is adapted to engage the groove when the pawl carrier is rotated to cause one of the first and second pawls to disengage from the toothed portion and the other of the first and second pawls to engage the toothed portion; and
a raised portion disposed on a portion of a perimeter of the cavity and protruding radially inward towards a center point of the cavity, wherein a first side of the raised portion engages with the pawl carrier to arrest rotation of the pawl carrier in the first drive direction and a second side of the raised portion engages with the pawl carrier to arrest rotation of the pawl carrier in the second drive direction.

2. The tool of claim 1, wherein the first side of the raised portion is disposed opposite the second side.

3. The tool of claim 1, wherein the first and second sides of the raised portion have an arcuate profile.

4. The tool of claim 3, wherein the arcuate profile of the first and second sides is the same.

5. The tool of claim 4, wherein the cavity has a first radius and the arcuate profile of the first and second sides is defined by a second radius less than the first radius.

6. The tool of claim 1, wherein the raised portion further comprises a third side disposed between the first and second sides, wherein the third side forms an angle with the first and second side.

7. The tool of claim 6, wherein the third side has an arcuate profile different than the first and second sides.

8. The tool of claim 6, wherein the first side and the third side form a first peak and the second side and third side form a second peak.

9. The tool of claim 8, wherein the first peak arrests rotation of the pawl carrier in the first drive direction and the second peak arrests rotation of the pawl carrier in the second drive direction.

10. The tool of claim 9, wherein a ball is partially recessed within the cavity such that the ball is selectively engaged with the pawl carrier, and wherein the first peak is on a first side of the ball and the second peak is on a second side of the ball.

11. A tool head including a cavity, and a ratchet gear assembly arranged within in the cavity, the tool head comprising:
a pawl carrier arranged in the cavity to cooperate with the ratchet gear assembly;
a first pawl and a second pawl supported within the pawl carrier and positioned to selectively engage with the ratchet gear assemble, wherein the selectively engagement includes the first pawl engaging the ratchet gear assembly to select a first drive direction, and the second pawl engaging the ratchet gear assembly to select a second drive direction; and
a raised portion provided on a perimeter of the cavity, wherein the raised portion extends radially inward towards a center point of the cavity, wherein a first side of the raised portion cooperates with the pawl carrier to arrest rotation of the pawl carrier in the first drive direction, and wherein a second side of the raised portion cooperates with the pawl carrier to arrest rotation of the pawl carrier in the second drive direction.

12. The tool head of claim 11, wherein the first side of the raised portion is disposed opposite the second side.

13. The tool head of claim 11, wherein the first and second sides of the raised portion have an arcuate profile.

14. The tool head of claim 13, wherein the arcuate profile of the first side and is the same as the arcuate profile of the second side.

15. The tool head of claim 14, wherein the cavity has a first radius and the arcuate profile of the first and second sides is defined by a second radius less than the first radius.

16. The tool head of claim 11, wherein the raised portion further comprises a third side disposed between the first and second sides, wherein the third side forms an angle relative to the first and second side.

17. The tool head of claim 16, wherein the third side has an arcuate profile different than the arcuate profile of the first and second sides.

18. The tool head of claim 16, wherein the first side and the third side form a first peak and the second side and third side form a second peak.

19. The tool head of claim 18, wherein the first peak arrests rotation of the pawl carrier in the first drive direction and the second peak arrests rotation of the pawl carrier in the second drive direction.

20. The tool head of claim 19, wherein a ball is partially recessed within the cavity such that the ball is selectively engaged with the pawl carrier, and wherein the first peak is on a first side of the ball and the second peak is on a second side of the ball.
